(19) United States
(12) Patent Application Publication
(10) Pub. No.: US 2005/0230142 A1
(43) Pub. Date: Oct. 20, 2005

(54) Electrical closure apparatus having wall impression members

(75) Inventor: Cong Thanh Dinh, Collierville, TN (US)

Correspondence Address: G. ANDREW BARGER;THOMAS & BETTS CORPORATION, 8155 T&B BOULEVARD 4B-36, MEMPHIS, TN, 38125, US

(73) Assignee: Thomas & Betts International, Inc., Wilmington, DE (US)

(21) Appl. No.: 10/824,045

(22) Filed: Apr. 14, 2004

(51) Int. Cl. H01H 9/02

(52) U.S. Cl. 174/66

(57) ABSTRACT

An electrical closure apparatus is provided for installing in a wall. The electrical closure apparatus includes a front face and a recessed portion to which the front face is formed. The electrical closure apparatus further includes a rear face disposed opposite the front face, on the recessed portion. At least one impression member is spaced from the recessed portion such that an outline is made, at least partially, of the recessed portion when pressed against the wall.

### FIELD OF THE INVENTION

The present invention relates generally to electrical closure apparatuses for installing switches, electrical outlets, telephone jacks, coaxial cable, and data jacks to a wall's surface. More particularly, the present invention relates to one or more impression members disposed on an electrical closure apparatus for defining, at least partially, a cutout or punch out area on a wall's surface for installing the electrical closure apparatus.

### BACKGROUND

There are two manners of construction involving electrical closure apparatuses such as electrical wall boxes and faceplates. One is “old work” in which the electrical apparatus is installed in existing construction, and the other manner is “new work” in which a suitably sized electrical apparatus is added to a structure that is in the process of being built or remodeled. In old work situations an installer must remove a square or rectangular portion of the wall to create an aperture into which the electrical box is inserted, with swing arms typically used to secure it to the wall. Likewise, an aperture must be created in the wall if only a low voltage faceplate without a box is being used to allow for cable, stereo, telephone and data communication access through the wall via the faceplate.

Installers typically must use a template upon which they mark the area for the cutout or they use a knife to mark the corners of cutout. Many times these imprecise markings result in the cutout being off centered, thereby making the installed electrical closure apparatus canted on the wall. Other times the marked area will be too large, which could expose the unsightly interior of the wall, or the marked area will be too small and further cutting of the wall is required to make the electrical closure apparatus fit. This often disfigures the wall.

Accordingly, it is desirable to have one or more protrusions disposed on the rear or front of an electrical box or faceplate whereby an installer can simply press the box or faceplate against the wall and make an outline, or at least a portion thereof, where the wall must be cut

### SUMMARY OF THE INVENTION

The present invention eliminates the above difficulties and disadvantages by providing an electrical closure apparatus, such as but not limited to an electrical box or low voltage wall box or faceplate, for installing in a wall that includes at least one impression member for marking or scoring the wall so that an installer can make an accurate cutout or punch out of the area.

The low voltage faceplate includes a front face that defines a front area. The electrical closure apparatus further includes a rear face disposed opposite the front face, the rear face defining a rear area less than or equal to the front area. At least one impression member is spaced from the rear face such that an outline is made, at least partially, of the rear face or at least one connector port when pressed against the wall.

### BRIEF DESCRIPTION OF THE DRAWINGS

FIG. 1 is a front elevational view of an electrical closure apparatus of the present invention.

FIG. 2 is a rear perspective view of the electrical closure apparatus of the present invention.

FIG. 3 is a rear perspective view of the electrical closure apparatus of FIG. 2 showing an alternate embodiment.

FIG. 4 is a rear perspective view of the electrical closure apparatus of FIG. 2 showing another alternate embodiment.

FIG. 5 is a front perspective view of a box-type electrical closure apparatus of the present invention.

FIG. 6 is a rear perspective view of the box-type electrical closure apparatus of the present invention.

FIG. 7 is a perspective view of the box-type electrical closure apparatus of FIG. 5 showing an alternate embodiment.

FIG. 8 is a perspective view of the box-type electrical closure apparatus of FIG. 5 showing another alternate embodiment.

### DETAILED DESCRIPTION OF THE PREFERRED EMBODIMENT(S)

The above and other features, aspects, and advantages of the present invention will now be discussed in the following detailed description and appended claims, which are to be considered in conjunction with the accompanying drawings in which identical reference characters designate like elements throughout the views.

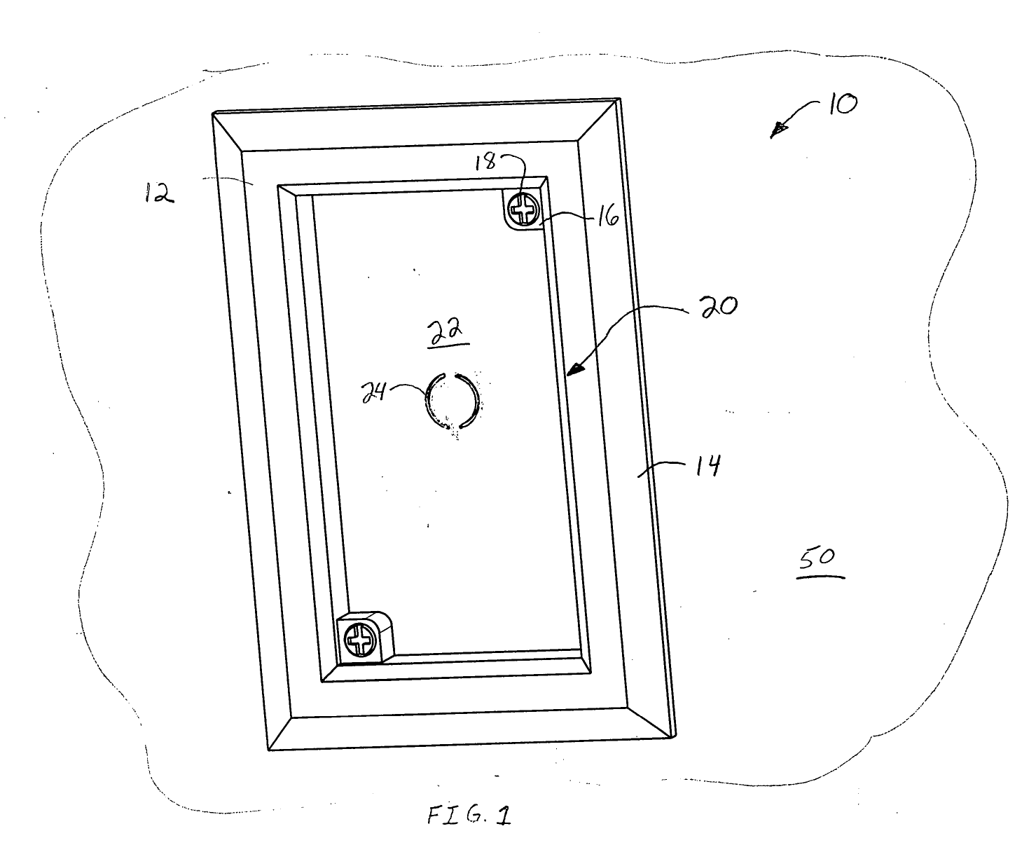

Shown in FIG. 1 is an electrical closure apparatus 10, for “old work” applications such as when apparatus 10 is installed in an existing wall. The electrical closure apparatus 10 shown in FIG. 1 is a low voltage faceplate (but is not limited to) for installing in a wall 50 that allows for marking or scoring the wall 50 so that an installer can make an accurate cutout or punch out of the area needed to install the apparatus 10 or simply of one or more connector ports 24. The apparatus 10 is preferably constructed of nylon, but could be constructed of any thermo-plastic that is relatively hard and durable. The construction can also be of metal such as galvanized metal. The electrical closure apparatus 10 includes a bounding edge or front edge 14 that abuts wall 50 when the apparatus 10 is installed therein. A front face 22 is integrally formed with bounding edge 14 and defines a front area. The front face 22 has at least one connector port 24 disposed therein. One or more connector ports are installed in front face 22 such as ports for low voltage cable TV connectors, telephone jacks, data communication jacks, stereo jacks, and the like. Port 24 is an aperture or scored or stressed material such that an installer can easily remove the material. While the embodiments shown in FIGS. 1-4 show the front face 22 and bounding edge 14 as defining a recessed portion 20, front face 22 can be flush with bounding edge 14. An advantage of having the recessed portion 20 is that the associated connector that is disposed in port 24 will also be recessed, at least partially within from the outside of wall 50.

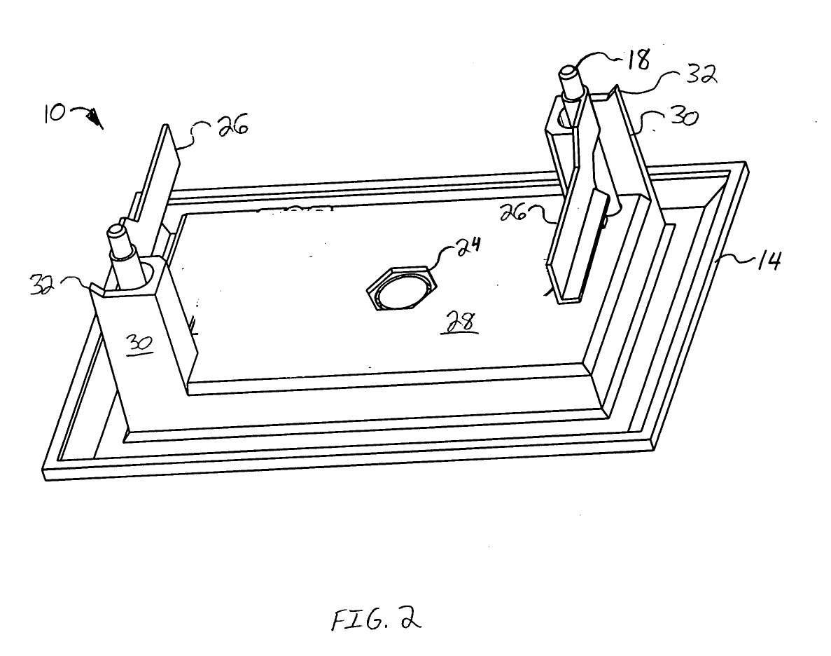

As is further shown in FIG. 1, screw ports 16 are provided and integrally molded with bounding edge 14 wherein screws 18 are installed. The extension of screws 18 is shown in FIGS. 2-4. Wall attachment means 26, such as but not limited to anchoring devices or swing arms that rotate to abut the inside of wall 50 when the screws 18 are rotated, are also provided. The wall attachments means could also be sharp points or cone-shaped members for pressing into wall 50. When the attachment means 26 abut the inside of wall 50, compression is created between the attachment means 26 and bounding edge 14 to retain apparatus 10 on the wall 50. Also shown in FIGS. 2-4 is rear face 28 that is disposed opposite front face 22, the rear face 28 defining a rear area less than or equal to the front area. In the present embodiment, the rear area is equal to the surface area of the front face 22. If, however, apparatus 10 is flush with wall 50 such that there is no faceplate recessed portion 20, the rear area is defined by the attachment means 26 disposed in the apparatus 10, form two corners of a rectangle, and that adhere it to wall 50.

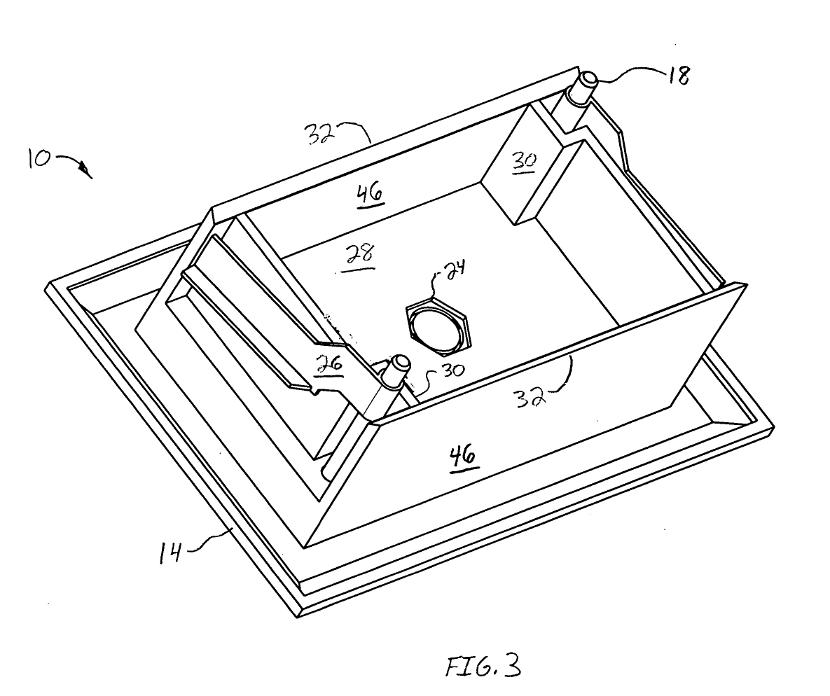

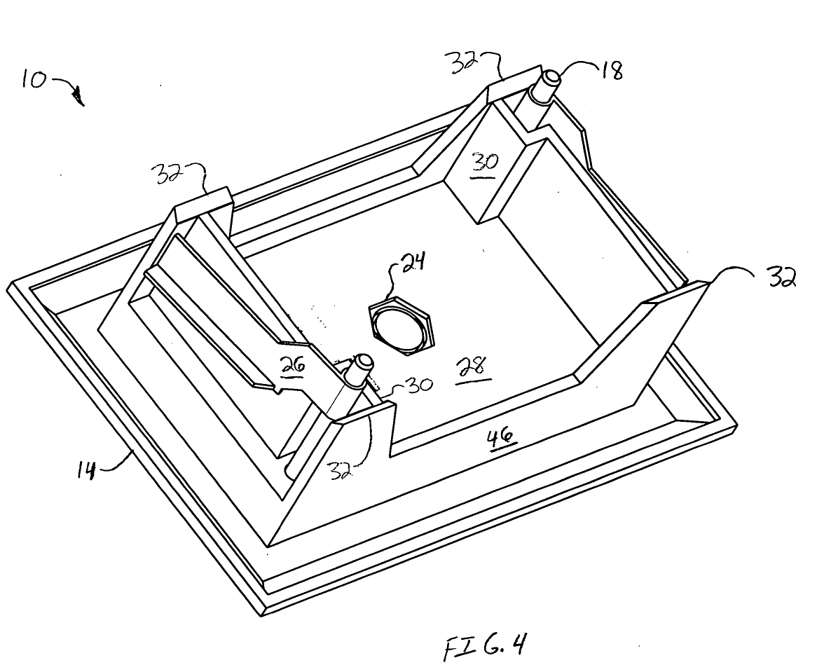

As best shown in FIG. 2, standoffs 30 at least partially surround the extension portion of screws 18 and are considered part of recessed portion 20. At least one impression member 32 is spaced from rear face 28 such that a two-dimensional outline is made, at least partially, of the rear face 28 or recessed portion 20 when impression member 32 is pressed against wall 50. Impression member 32 can take many contemplated forms in nearly any raised projection such as points, half spheres, edges (bounding, two sides, or partial), or any other raised geometric shape capable of making an impression in wall 50. In the preferred embodiment of the apparatus 10 shown in FIG. 2, the impression member 32 is integrally formed with standoff 30 and takes the form of points for making an impression in wall 50 when pressed against it. In the embodiment shown in FIG. 3, the impression member 32 takes the form of two edges that span the length of rear face 28 and are integrally formed with side wall 46. While in FIG. 4, the impression member 32 is four elongated edges that are raised from and extend lengthwise from the corners of rear face 28 and are integrally formed with side wall 46.

The impression member 32 of FIGS. 1-4 can be formed on front edge 14 as well as on rear face 28 or stand of 30. In addition, impression member 32 can be formed, at least partially, about each port 24 if only an area for the cutout is to be made for each apparatus in wall 50. This is typically the case when the low voltage faceplate is not recessed, but rather flat.

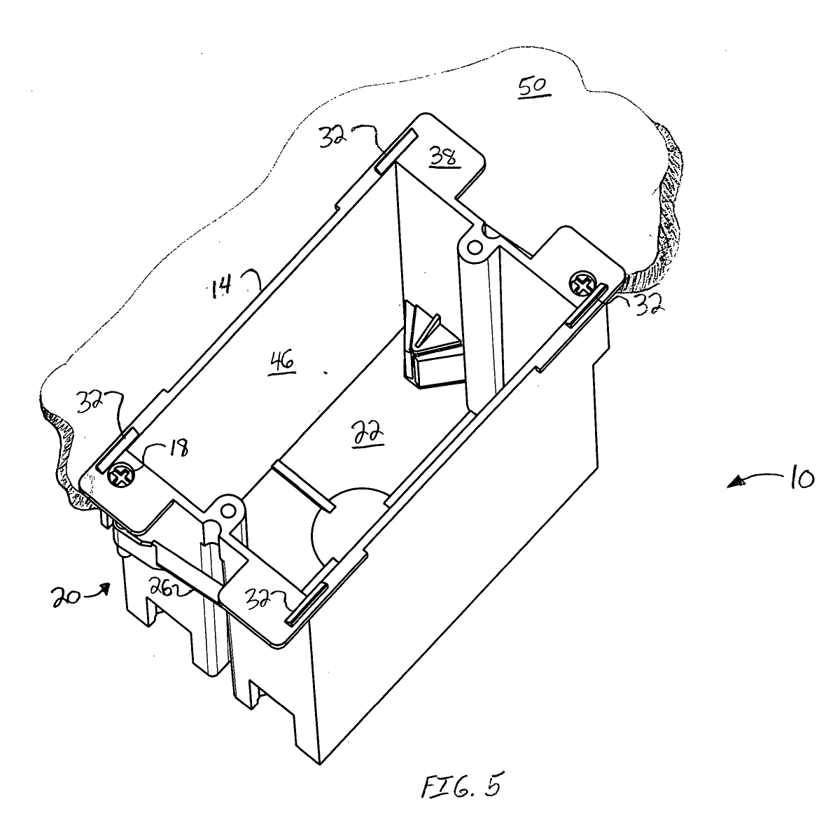

Shown in FIG. 5 is an electrical closure apparatus 10, for “old work” applications when apparatus 10 is installed in an existing wall. The electrical closure apparatus 10 shown in FIG. 5 is a high voltage box (but is not limited to), for installing in a wall 50 that allows for marking or scoring the wall 50 so that an installer can make an accurate cutout or punch out of the area needed to install the apparatus 10. The apparatus 10 is preferably constructed of nylon, but could be constructed of any thermo-plastic that is relatively hard and durable. The construction can also be of metal such as galvanized metal.

The electrical closure apparatus 10 includes front edge 14 that abuts wall 50 when the apparatus is installed therein to prevent the apparatus 10 from falling into the wall 50. Edge 14 bounds apparatus 10 or is a partial edge and is preferably integrally formed with side walls 46. Further included in apparatus 10 is a front face 22 that is integrally formed within the apparatus 10 and integrally formed to the four bounding side walls 46. The side walls 46 and front face 22 form a recessed portion 20 to which front edge 14 is integrally coupled.

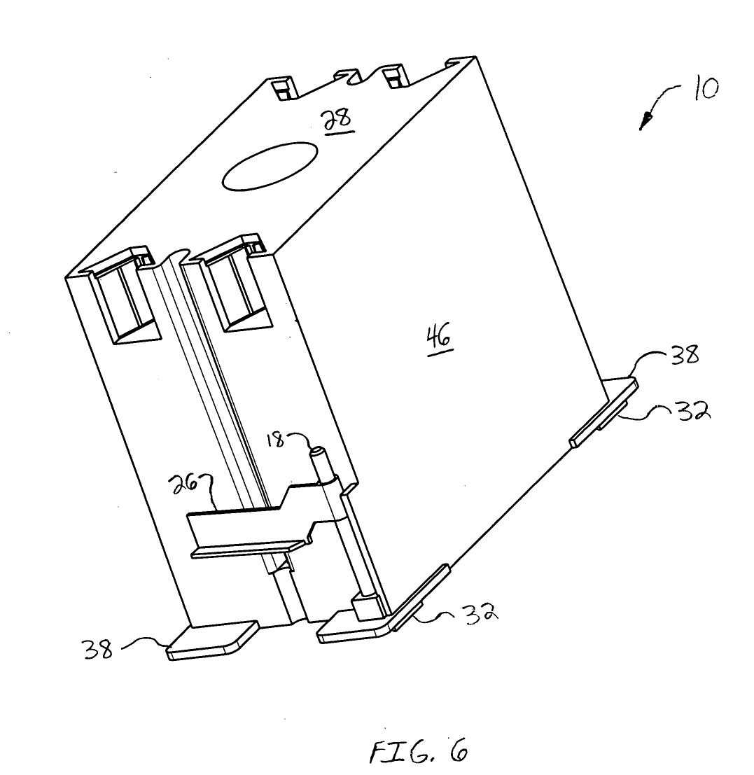

As is further shown in FIG. 5, screws 18 are installed in flanges 38. The extension of screws 18 along side walls 46 is shown in FIGS. 6-8. Wall attachment means 26, such as but not limited to anchoring devices or swing arms that rotate to abut the inside of wall 50 when the screws 18 are rotated, are also provided. Side walls 46 and wall attachment means 26 define a recessed portion 20 for installing within wall 50, the recessed portion 20 having a given area. If, however, wall attachment means 26 were disposed within, at least partially, side walls 46, then recessed portion 20 would be defined by the side walls 46 and face 22.

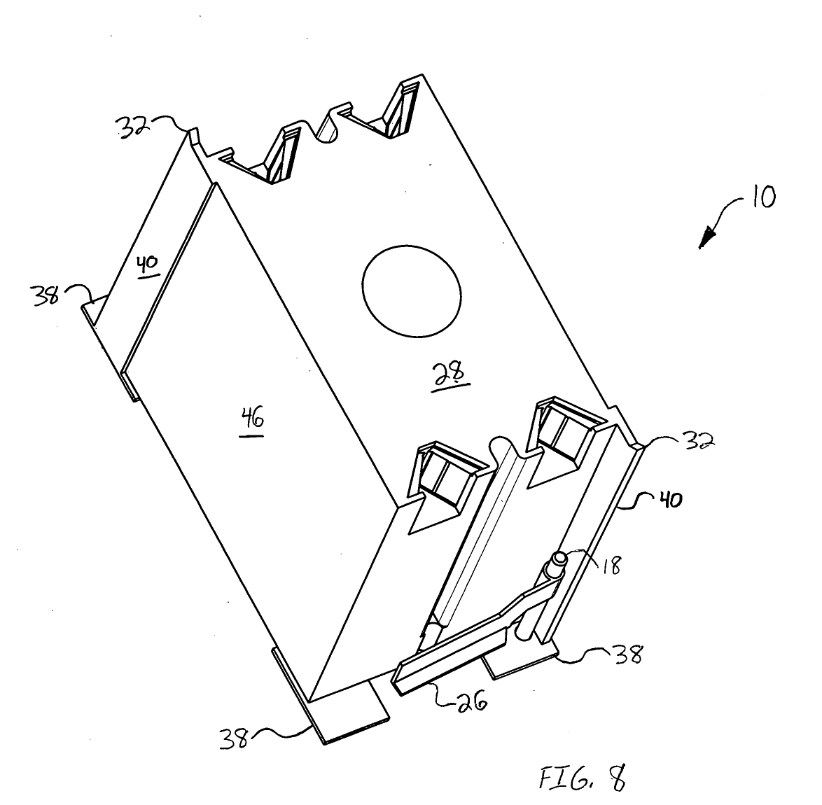

When the attachment means 26 abut the inside of wall 50, compression is created between the attachment means 26 and front edge 14 to retain apparatus 10 on the wall 50. Further shown in FIGS. 6 and 8 is rear face 28 that is disposed opposite the front face 22. The rear face 28 defines a rear area less than or equal to the front area. In the present embodiment, the rear area is equal to the surface area of rear face 28.

As shown in the embodiment of FIGS. 5 and 6, at least one impression member 32 is raised from front edge 14 and integrally formed therewith. Preferably, however, four elongated impression members 14 are spaced from the front edge 14 such that an outline is made, at least partially, of the four corners defining recessed portion 20 when impression member 32 is pressed against wall 50. Impression member 32 can take many contemplated forms in nearly any raised projection such as points, half spheres, edges (bounding, two sides, or partial), or any other raised geometric shape capable of making an impression in wall 50.

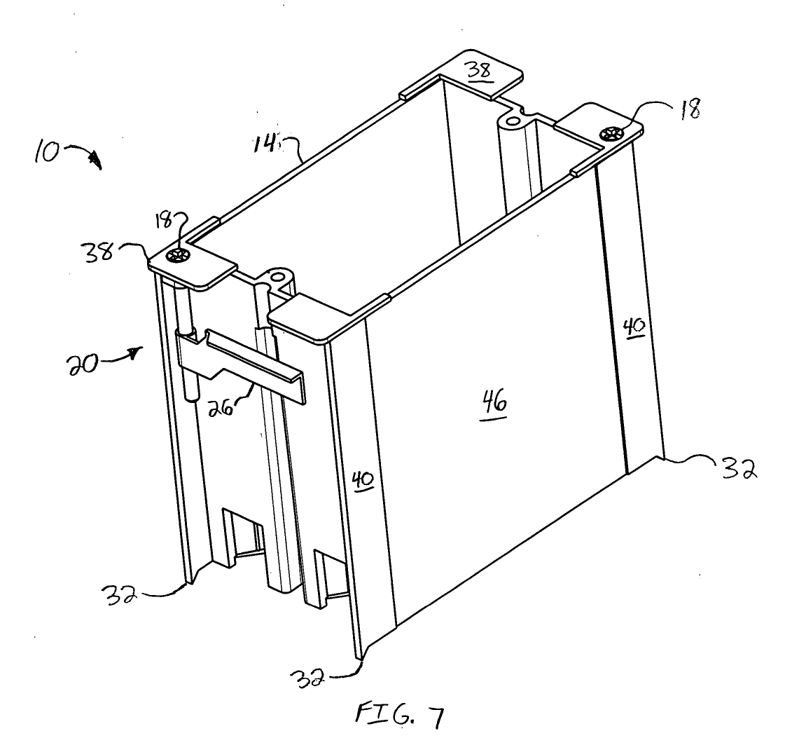

In the embodiment of the apparatus 10 shown in FIGS. 7 and 8, the impression member 32 is integrally formed on extensions 40 that run lengthwise along walls 46. Impression members 32 take the form of points for making an impression in wall 50 when pressed against it. These impression members 32 extend from recessed portion 20 such that a two-dimensional outline is made, at least partially, of the given area of the recessed portion 20 when the impression member is pressed against wall 50. This embodiment is not as desirable as that shown in FIGS. 5 and 6 since it is more costly to manufacture given the extra material needed to form extensions 40. Also, in this embodiment the recessed portion 20 is defined by the extensions 40 disposed in the apparatus 10, which are molded to cover the length of side walls 46 and diameter of wall attachment means 26 as disposed outside of side walls 46.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above mentioned description is to be considered exemplary, rather than limiting, and the true scope of the invention is that defined in the following claims.

1. An electrical closure apparatus for installing in a wall, the electrical apparatus comprising:
a front face defining a front area for abutting the wall;
a rear face disposed opposite the front face and having four corners, the rear face defining a rear area less than or equal to the front area and for installing, at least partially, within the wall; and
at least one impression member spaced from the rear face such that an outline is made, at least partially, of at least two of the four corners when the rear face is pressed against the wall.

2. The electrical closure apparatus of claim 1 wherein the impression member is a point.

3. The electrical closure apparatus of claim 1 wherein the impression member is a raised edge.

4. The electrical closure apparatus of claim 1 wherein the impression member is integrally formed on the front face.

5. The electrical closure apparatus of claim 4 wherein the impression member is spaced from the front face.

6. (canceled)

7. The electrical closure apparatus of claim 1 wherein an outline is made, at least partially, of the four corners when the rear face is pressed against the wall.

8. An electrical closure apparatus for installing in a wall, the electrical apparatus comprising:
a recessed portion for installing within the wall;
a front edge coupled to the recessed portion, the edge for abutting the wall when the electrical closure apparatus is installed; and
at least one impression member secured to the electrical closure apparatus such that a two-dimensional outline is made, at least partially, of the recessed portion when the impression member is pressed against the wall.

9. The electrical closure apparatus of claim 8 wherein the impression member is a point.

10. The electrical closure apparatus of claim 8 wherein the impression member is a raised edge.

11. The electrical closure apparatus of claim 8 wherein the impression member is a geometric shape.

12. The electrical closure apparatus of claim 8 wherein the recessed portion includes a wall attachment means coupled thereto.

13. The electrical closure apparatus of claim 12 wherein the recessed portion includes a wall attachment means coupled thereto.

14. The electrical closure apparatus of claim 8 wherein the impression member extends from and is integrally formed with the recessed portion.

15. The electrical closure apparatus of claim 8 wherein the impression member extends from and is integrally formed with the given edge.

16. An electrical closure apparatus for installing in a wall, the electrical closure apparatus comprising:
four bounding side walls;
a rear wall coupled to the four bounding side walls and having a front face and a rear face disposed opposite the front face;
a recessed portion formed by the four side walls and the rear wall for installing within the wall;
a front edge integrally formed with the four bounding side walls for abutting the wall when the electrical closure apparatus is installed therein; and
at least one impression member disposed on the electrical closure apparatus for making an outline, at least partially, of the recessed portion on the wall when pressed there against.

17. The electrical closure apparatus of claim 16 wherein the impression member is a geometric shape.

18. The electrical closure apparatus of claim 16 wherein the impression member is a raised edge.

19. The electrical closure apparatus of claim 16 wherein the impression member is formed on the recessed portion and raised therefrom.

20. The electrical closure apparatus of claim 16 wherein the impression member is formed on the front edge and raised therefrom.
